(19) United States
(12) Patent Application Publication
(10) Pub. No.: US 2026/0251090 A1
(43) Pub. Date: Aug. 27, 2026

(54) ROTARY ENGINE WITH INTERNAL ARC-SECTOR ACTUATION

(71) Applicant: Joshua May, Portland, OR (US)

(72) Inventor: Joshua May, Portland, OR (US)

(21) Appl. No.: 19/547,568

(22) Filed: Feb. 23, 2026

Related U.S. Application Data
(60) Provisional application No. 63/762,079, filed on Feb. 23, 2025.

(51) Int. Cl. F02B 55/02; F02B 53/10; F02B 53/12; F02B 55/08; F02B 55/14; F02B 63/04; F02D 43/04; F02P 5/15

(52) U.S. Cl. CPC F02B 55/02; F02B 53/10; F02B 53/12; F02B 55/08; F02B 55/14; F02B 63/042; F02D 43/04; F02P 5/1502

(57) ABSTRACT

A rotary engine includes a housing, a driveshaft, and a rotating cylindrical body coupled to the driveshaft for continuous rotation about a rotational axis. One or more internal arc-shaped sector elements are arranged to move relative to the rotating cylindrical body and cooperate with the rotating cylindrical body and the housing to define a variable-volume combustion chamber. Relative motion between the rotating cylindrical body and the arc-shaped sector elements produces intake, compression, expansion, and exhaust phases during engine operation while maintaining continuous rotation of the driveshaft. Combustion within the combustion chamber applies incremental torque to the rotating cylindrical body to produce rotational output. In some embodiments, multiple sector elements or engine modules are arranged in phased relationships to smooth torque delivery. Intake and exhaust flow may be controlled through timed porting. In some embodiments, the driveshaft is coupled to or formed as an electric motor-generator to provide baseline rotational torque, assist startup, and stabilize rotational speed during operation.

### RELATED APPLICATIONS

This application claims the benefit of U.S. Provisional Application Ser. No. 63/762,079, filed Feb. 23, 2025 entitled Rotary Actuation Engine, the entire disclosure of which is herein incorporated by reference.

### FIELD OF THE INVENTION

This application relates to internal combustion engines, and more particularly, rotary engines.

### PRIOR ART

U.S. Pat. No. 3,851,630 issued on Dec. 3, 1974, to Merrill J. Foster and is titled Rotary Piston Engine. This patent discloses a rotary compound engine employing opposed combustion cylinders extending radially on an output shaft, pistons displaceable within the cylinders and having rods connected to each other, an eccentric stationarily mounted, bearing means connecting the piston rods to the eccentric so that actuation of the pistons causes rotation of the output shaft, cooling coils around the path of the cylinders and containing fluid for absorbing heat, a turbine driven by evaporated fluid from the cooling coils for returning power to the output shaft, a radiator for condensing the fluid media from the turbine, a pressure pump for returning the fluid media to the combustion area, a fan on the output shaft for circulating air through the radiator, a cowling for directing air from the radiator past the cooling coils, an annular fuel tank mounted in the end of the cowling opposite from the fan, and a carburetor mounted in the central space of the fuel tank for communicating the fuel tank with the cylinders. While this patent is for a rotary engine, the engine uses opposing combustion chambers.

U.S. Pat. No. 5,738,065 issued on Apr. 14, 1998, to Jean Linnel and is titled Variable Rotary Engine. This patent discloses a rotary engine contains a laterally displaceable rotary member which is sealably and slidably engaged by a rotor plate which has been modified for sealing, travels in an eccentric circle along with the rotor, but provides sealing against the rotor using corner seals and surface seals, and is also further sealed against the engine housing so that combustion gasses in the vicinity of the rotor and rotor plate do not escape either between the rotor and rotor plate surfaces nor between the rotor plate surfaces and the engine housing surfaces. The other end of the rotor rotatably depends from a reducing piston which is sealably engaged against the internal portion of the engine so that it can travel laterally, in order to laterally displace the rotor. During engine operation, the rotor can be made to be axially displaced or pushed through the rotor plate to lower the effective combustion volume. The reducing piston is physically manipulated from outside of the engine by actuation of a plurality of push-pull rods which connect the reducing piston ultimately to an actuator. An actuator is used to operate the push-pull plate and a sensor can be utilized to measure the displacement of the push-pull rods and plate to better control the resulting engine displacement. While this patent discloses a rotary engine, the engine uses a rotating tri-lobular piston.

U.S. Pat. No. 6,668,767 issued on Dec. 30, 2003, to Sanchez Talero et al. and is titled Internal Combustion Engine Rotatory (turbovolante). This patent discloses a rotary engine having at least two piston blades that may be actuated by either internal combustion or electromagnetic actuation. The combustion engine includes piston blades having a toothed moving pinion connected to each piston blade and a toothed fixed pinion geared to the toothed moving pinions. The gear ratio of the toothed fixed pinion to the toothed moving pinions is one half the number of piston blades to one. While this patent discloses a rotary engine, the engine uses piston blades that rotate and oscillate around the inside of the housing.

U.S. Patent Publication Number 20100319653 was published on Dec. 23, 2010, to George Jerzy Zalewski and is titled Reduced Friction Rotary Combustion Engine. This publication discloses an axial vane rotary combustion engine includes various performance improving features. These features include fluid film bearings that enable the vane assemblies to react large loads, a dual vane assembly configuration that share vane loads over two cylindrical bearing supports, a vane actuation mechanism that provides positive actuation even with cam surface tolerance variations, and various features to reduce friction to thereby improve efficiency and reduce heat generation. While this publication discloses a rotary engine, the engine uses blades the translate and they spin around the shaft.

What is needed is an engine configured to generate mechanical output through rotary actuation in which torque is applied directly to a driveshaft through controlled relative rotation of internal components, rather than through reciprocating motion converted by a crankshaft. In some embodiments, the driveshaft is coupled to or formed as an electric motor-generator. In some embodiments, the driveshaft is coupled to or formed as an electric motor-generator.

### BACKGROUND OF THE INVENTION

This invention relates to improvements in internal combustion engines and rotary power systems. Most conventional engines employ reciprocating pistons mechanically coupled to a crankshaft, resulting in cyclic inertial loads and energy losses associated with converting linear motion into rotational motion. Alternative rotary engine configurations have been developed, including designs that utilize a multi-lobed rotor to accomplish intake, compression, expansion, and exhaust cycles; however, such designs present challenges related to sealing, thermal distortion, and load distribution. The engine disclosed herein departs from both reciprocating piston architectures and multi-lobed rotary designs by employing a rotating cylindrical body that cooperates with one or more internal arc-shaped sector elements. The rotating cylindrical body provides continuous rotational inertia and serves as a primary rotating element, while the arc-shaped sector elements are configured to define and modulate combustion chamber volume and to control the timing and routing of intake and exhaust gases. In some embodiments, the geometry and phasing of the rotating and sector elements contribute to smoother torque delivery and reduced vibration during operation.

### SUMMARY OF THE INVENTION

It is an object of the rotary actuation engine to utilize a rotating cylindrical body in cooperation with one or more internal arc-shaped sector elements to define and modulate combustion chambers while maintaining continuous rotation of an output shaft. In some embodiments, multiple sector elements or engine modules are arranged in phased or opposing angular relationships to smooth torque delivery and reduce vibration. Intake, compression, expansion, and exhaust events are temporally offset about the rotational axis such that combustion contributes incremental torque to an already rotating system, thereby providing a more continuous transfer of power to the output shaft. The arc-shaped sector elements are configured to move relative to the rotating cylindrical body to vary chamber volume and control gas flow during engine operation.

It is an object of the rotary engine to control intake and exhaust flow using valve or porting arrangements positioned external to or integrated with the housing. Such valve or porting arrangements may operate mechanically, hydraulically, electrically, or through a combination thereof. In some embodiments, the internal arc-shaped sector elements include recesses, channels, or reliefs configured to permit passage of intake and exhaust gases between adjacent combustion chambers or engine modules while maintaining chamber definition during compression and expansion phases.

It is another object of the rotary engine to transmit combustion-generated torque directly to an output shaft through continuous rotational motion of a rotating cylindrical body, thereby reducing or eliminating reliance on reciprocating components and crankshaft mechanisms. The output shaft may be configured to drive one or more auxiliary systems, including but not limited to valve trains, electrical generators, alternators, fans, pumps, compressors, or other timed or rotationally driven devices.

In some embodiments, magnetic elements may be incorporated to assist operation of auxiliary components or control mechanisms. Such magnetic elements may be used, for example, to actuate valves, sensors, or latching components, or to assist in positioning or biasing internal elements. The magnetic elements are not required to produce net mechanical output power and are not relied upon as a primary source of propulsion or torque generation.

It is still another object of the rotary engine to employ electronic control systems to coordinate operation of fuel delivery, ignition timing, intake and exhaust flow, and relative motion of internal components. In some embodiments, such control systems may include adaptive or model-based control algorithms implemented using programmable controllers or variable-frequency drives to adjust engine operation in response to rotational speed, load, and operating conditions.

Combustion reaction forces generated within the combustion chamber are transmitted through the arc-shaped sector element and the rotating cylindrical body into the housing and driveshaft through defined bearing and support structures. In operation, external loads applied to the driveshaft, such as electrical generators, transmissions, or driven accessories, provide resistance against which combustion-generated torque performs useful work. The rotating cylindrical body provides rotational inertia that smooths torque fluctuations but does not eliminate reaction forces transmitted through the structure.

In some embodiments, the arc-shaped sector element 31 is held in a stopped position during compression and expansion phases primarily by combustion pressure rather than by an actively actuated latch. The sector 31 pivots about the driveshaft 30 and has a stop surface that engages a fixed reaction stop formed in the housing or engine block 29 when the sector reaches a defined compression position. When the sector 31 contacts the reaction stop, further rotation of the sector in the direction of rotor rotation is mechanically constrained, while the flywheel rotor 32 remains free to rotate with the driveshaft 30. During operation, relative rotation between the flywheel rotor 32 and the sector 31 decreases the volume of a combustion chamber defined between a rotor face and a corresponding face of the sector 31 until a minimum-volume condition is reached. Near this condition, an ignition device 60 initiates combustion of an air-fuel mixture in the chamber. The resulting combustion pressure acts on both the rotor face and the sector face, but because the sector 31 is in contact with the reaction stop, combustion forces transmitted to the sector are reacted into the housing 29 through the stop surface. Combustion pressure therefore produces a net tangential torque on the rotor 32 and the driveshaft 30 while simultaneously urging the sector 31 against the stop with a holding force substantially greater than inertial or friction forces tending to move the sector . In one illustrative configuration, a combustion pressure of approximately 60 bar acting on a chamber area of about 4.4 square centimeters produces a normal force on the sector on the order of 2,600 newtons, which is sufficient to maintain the sector in positive contact with the reaction stop throughout the expansion stroke even in the presence of transient inertial loads. As a result, the sector 31 remains effectively locked in a fixed angular position relative to the housing 29 during at least a portion of the compression and expansion phases without requiring a powered pawl, brake, or solenoid. After the expansion phase, continued rotation of the rotor 32 brings the trailing edge of the rotor into communication with an exhaust passage 41, placing the expanded combustion products in fluid communication with an exhaust port region 42 as shown in FIG. 2E. As cylinder pressure decays during blowdown and exhaust, the normal force between the sector 31 and the reaction stop decreases. The geometry of the sector 31 and rotor 32 may be configured such that residual gas pressure and rotor-induced flow forces acting on exposed sector surfaces generate a net moment on the sector that is sufficient to overcome friction at the stop interface and initiate sector rotation away from the stop. This allows the sector 31 to follow a return or exhaust-sweep motion profile, reducing chamber volume behind the trailing rotor edge and pushing remaining exhaust gases through the exhaust passage 41. In some embodiments, two combustion events in angularly spaced chambers may be phased such that pressure rise in a leading chamber urges the sector 31 into engagement with the reaction stop at the beginning of a compression dwell, while pressure decay and gas flow in a trailing chamber assist in releasing the sector from the stop at the beginning of an exhaust sweep. In this manner the arc-shaped sector element 31 may be held and released in coordination with the combustion cycle using pressure-derived forces and simple mechanical stops, without the need for complex active locking actuators.

In some embodiments, the rotary actuation engine is configured as a torque-augmentation system integrated with an electric motor or motor-generator. In such configurations, the driveshaft is continuously rotated by electromagnetic forces generated by the electric motor, and combustion within one or more variable-volume chambers applies incremental tangential torque to the rotating cylindrical body during selected angular intervals. The electric motor thereby provides baseline rotational speed, startup capability, and dynamic speed control, while combustion contributes additional mechanical power to the same shaft without being required to initiate or sustain rotation independently.

By applying combustion-generated torque to an already rotating system, the rotary actuation engine may operate at reduced peak pressure and reduced duty cycle relative to a standalone internal combustion engine, while still increasing net shaft power and energy output. Such configurations may be advantageous in aerospace, hybrid propulsion, or high-power electric drive applications where energy density, sustained power output, or endurance are improved by supplementing electric power with controlled combustion torque. In these embodiments, the electric motor and the rotary actuation engine cooperate mechanically on a common shaft, and control of combustion timing, fuel delivery, and sector motion may be coordinated with motor operation to maintain stable rotational speed and load sharing.

The rotary engine of claim 1, further comprising at least one circumferential sealing ring positioned between the outer surface of the rotating cylindrical body and the inner surface of the housing, and at least one sealing ring at each axial end of the arc-shaped sector, wherein the seal rim or overlap lip cooperates with the sealing rings to define a timed port window while maintaining substantial sealing of the combustion chamber during compression and expansion phases-claim

The present invention uses an arc-shaped sector that is selectively locked stationary relative to the housing while the cylindrical rotor rotates continuously, such that the rotor trailing edge exposes the combustion chamber to the exhaust passage at the completion of expansion.

Various objects, features, aspects, and advantages of the present invention will become more apparent from the following detailed description of preferred embodiments of the invention, along with the accompanying drawings in which like numerals represent like components.

### BRIEF DESCRIPTION OF THE DRAWINGS

The invention description below refers to the accompanying drawings, of which:

FIG. 1 shows the internal components of a rotary actuation engine.

FIG. 2A-2F show the different cycles of the rotary actuation engine to produce output.

FIG. 3 shows a second embodiment of the rotary actuation engine.

FIG. 4 shows four rotary actuation engine modules connected through a common driveshaft.

FIG. 5 shows a magnetic rotary engine embodiment with a spinning cylinder.

FIG. 6 shows intake ports placed in 90-degree rotations around the four-module rotary actuation engine.

### DETAILED DESCRIPTION

It will be readily understood that the components of the present invention, as generally described and illustrated in the drawings herein, could be arranged and designed in a wide variety of different configurations. Thus, the following more detailed description of the embodiments of the system and method of the present invention, as represented in the drawings, is not intended to limit the scope of the invention but is merely representative of various embodiments of the invention. The illustrated embodiments of the invention will be best understood by reference to the drawings, wherein like parts are designated by like numerals throughout.

In operation, the rotating cylindrical body and the internal arc-shaped sector element cooperate to define a plurality of combustion chambers that are angularly adjacent and temporally offset about the rotational axis. As the rotating cylindrical body turns, a given circumferential region of the rotating cylindrical body and a corresponding region of the arc-shaped sector element may simultaneously participate in different phases of adjacent combustion cycles. For example, a first portion of a circumferential region may serve as a reaction surface for expansion of a first combustion chamber, while an adjacent portion of the same circumferential region concurrently contributes to compression of a second combustion chamber that trails the first chamber in the direction of rotation. Similarly, a portion of the arc-shaped sector element may simultaneously define a trailing boundary of one combustion chamber during expansion and a leading boundary of an adjacent combustion chamber during compression.

As a result, combustion forces and compression forces from multiple chambers may be transmitted through shared structural regions of the rotating cylindrical body and the arc-shaped sector element at the same time. These forces are superposed and resolved through the geometry of the rotating cylindrical body, the arc-shaped sector element, and associated bearing and support structures. When the chambers are angularly phased, the net tangential component of the resulting forces contributes torque to the rotating cylindrical body in a common rotational direction, while non-tangential components are reacted through the housing and support structure. This overlapping participation of structural regions in multiple combustion phases enables incremental torque contribution from multiple chambers during a single rotation, while maintaining continuous rotation of the driveshaft.

In some embodiments the system acts as as an electric motor-generator whose rotor is also a combustion rotor, with combustion events adding tangential torque at the rotor's outer edge while the shaft spins continuously. The driveshaft carries a cylindrical flywheel-like rotor that defines part of the combustion chamber boundary, and inside the housing an internal arc-shaped sector (the “flapper”) forms the other main boundary of the chamber; the sector can be locked to the housing or allowed to move relative to the rotor. During operation, the rotor spins about the shaft axis, driven partly by the electric machine and partly by combustion, and the control arrangement (cam track and follower, pawl/detent, or electromagnetic latch keyed to shaft angle) periodically locks the sector at specific angular positions to create dwell phases for compression and expansion, then releases it to sweep for intake and exhaust. In an intake phase, with the sector in an “open” angular position and unlocked, the growing volume between the rotating cylindrical rotor and the sector passes one or more fixed intake passages or ports in the housing or end plates, so fresh air-fuel mixture is drawn or injected into the chamber as the rotor edge sweeps by. For compression, the control arrangement holds the arc-sector at a fixed angle (compression dwell) while the rotor continues spinning; the relative motion between rotor and locked sector decreases the enclosed volume, compressing the trapped charge much like a piston approaching TDC, but here the motion is purely rotational. Near the point of minimum chamber volume, the ignition device fires; the sector remains locked, so high pressure acts on both the rotor face and the sector face, but the rotor is free while the sector reacts into its mechanical stop and the housing, so the net pressure distribution produces a tangential force at the rotor's outer edge that adds torque on the same shaft that the electric motor-generator uses. After the main expansion stroke, as the rotor edge exposes the chamber to an exhaust passage, the control releases the sector into an exhaust sweep profile (via cam ramp, pawl release, or de-energizing an electromagnetic latch) so that the sector rotates toward the rotor and pushes burnt gases out through the exhaust ports, returning the geometry to a new intake configuration without ever stopping or reversing the main shaft. Multiple modules can be stacked along the driveshaft and angularly phased (for example by 90 degrees) so that different chambers are in intake, compression, expansion, and exhaust at any given time, smoothing total torque while each module's arc-sector is independently locked and swept according to its local cam/latch timing. In that context, the electric machine provides baseline rotational speed, assists or resists torque as needed, and gives precise shaft-angle feedback, while combustion in each chamber acts as a periodic, shaft-synchronous torque assist at the rotor edge, effectively turning the machine into a coupled electro-combustion rotor where software-controlled locking of the internal arc-sector sculpts the pressure-volume cycle without any crankshaft or reciprocating pistons.

In operation, the arc-shaped sector element remains in continuous relative motion with respect to the rotating cylindrical body and is not required to be brought to a complete stop during compression or expansion phases. Combustion pressure within the variable-volume chamber biases the relative angular velocity between the rotating cylindrical body and the arc-shaped sector element such that a net tangential force is applied to the rotating cylindrical body. Reaction forces generated at the arc-shaped sector element are transmitted through bearing, pivot, and support structures into the housing, while useful work is extracted as rotational torque at the driveshaft. In this manner, torque is generated through pressure-biased relative motion rather than through impact against fixed stops or discrete locking mechanisms.

While this technology is susceptible of embodiment in many different forms, there is shown in the drawings and will herein be described in detail several specific embodiments with the understanding that the present disclosure is to be considered as an exemplification of the principles of the technology and is not intended to limit the technology to the embodiments illustrated. The terminology used herein is for the purpose of describing particular embodiments only and is not intended to be limiting of the technology. As used herein, the singular forms “a,” “an,” and “the” are intended to include the plural forms as well, unless the context clearly indicates otherwise.

It will be further understood that the terms “comprises,” “comprising,” “includes,” and/or “including,” when used in this specification, specify the presence of stated features, integers, steps, operations, elements, and/or components, but do not preclude the presence or addition of one or more other features, integers, steps, operations, elements, components, and/or groups thereof. It will be understood that like or analogous elements and/or components, referred to herein, may be identified throughout the drawings with like reference characters.

### ITEM NUMBERS AND DESCRIPTION

21 rotary actuation engine
29 engine block
30 driveshaft
31 flapper
32 flywheel rotor
40 exhaust tube
41 exhaust passage
42 exhaust port manifold
43 exhaust port
50 intake tube
51 intake passage
53 intake port
59 fuel injector
60 spark plug
61 ignition event or combustion
90 rotational direction or torque vector
91 flapper rotation during compression
92 flapper rotation riding exhaust

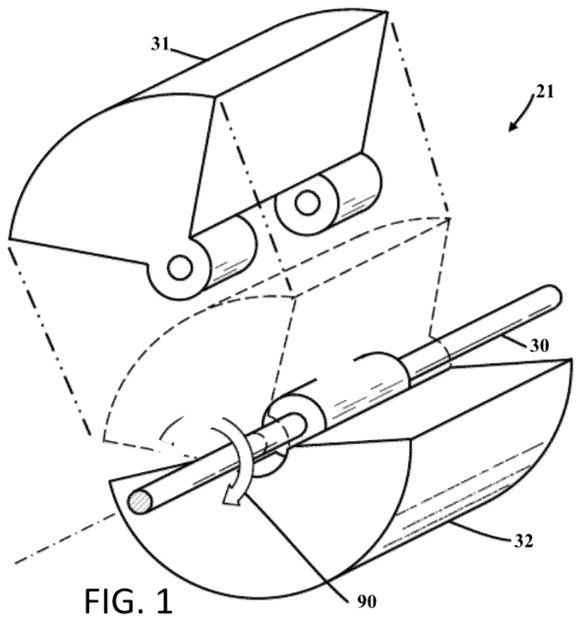

FIG. 1 shows the internal components of a rotary actuation engine 21. This figure shows a driveshaft 30 that transfers power to a transmission or other device. The driveshaft 30 has a flywheel rotor 32 that is fixed to the driveshaft 30. A flapper 31 is rotatably secured and pivots on the driveshaft 30. Movement of the flapper 31 operates in a cylindrical housing to perform the functions of intaking an air fuel into the engine, compressing the air fuel mixture, pushing the detonated expanding air fuel mixture to turn the flywheel rotor 32 and then expel the exhaust. This is all performed by the flapper 31 oscillating on the driveshaft 30. While a single set of flywheel rotor 32 and flapper 31 is shown, a plurality of these components can be placed along the driveshaft 30 to increase the output of rotary actuation engine 21. Other figures in this document show the different cycles of the rotary actuation engine 21 to power and drive the driveshaft 30.

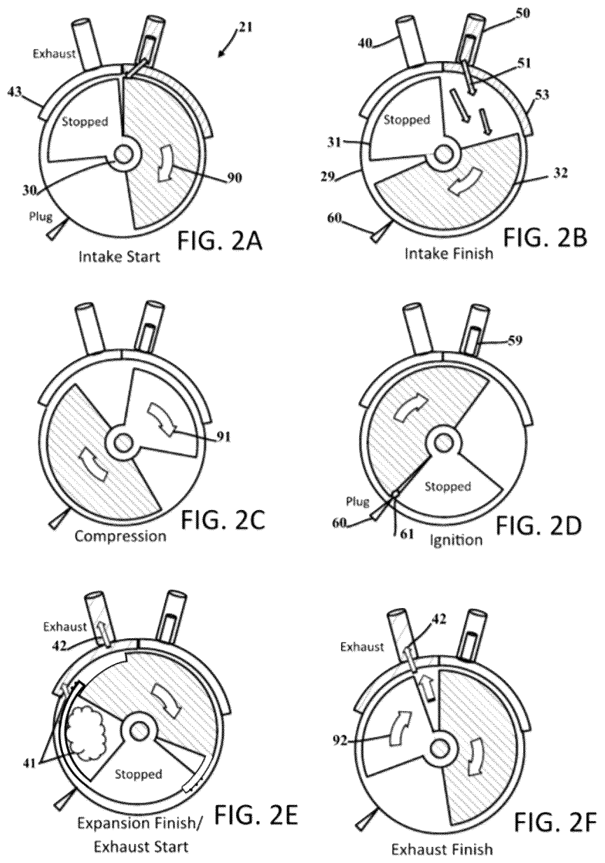

FIG. 2A-2F show the different cycles of the rotary actuation engine 21 to produce output. As a basic understanding of the components in each figure, the center shows the driveshaft 30 with the flywheel rotor 32 and the flapper 31. These are housed in an engine block 29. At the top right of each figure is an intake tube 50 connected to an intake port 53. On the top left side of each figure is an exhaust tube 40 connected to an exhaust port 43. The lower left corner a spark plug 60 is located.

Starting with FIG. 2A the rotary actuation engine 21 is at an initial condition as the intake cycle starts. The vertical edge of the flywheel rotor 30 is positioned between the exhaust port 43 and the intake port 53. The right side of the flapper 31 is against the vertical side of the flywheel rotor 32 and movement of the flapper 31 is essentially stopped. At this position intake port 53 opens and the flywheel rotor 32 turns or rotates 90. This allows air to enter the chamber and fuel to be injected into the air from a fuel injector 59. As the flywheel rotor 32 continues its rotation 90 more air and fuel enter behind the flywheel rotor 32.

In FIG. 2B the intake of the air-fuel mixture nears completion. Between FIGS. 2A and 2B the flapper remains essentially stationary. This can occur using a cam, lever arm, pin, cog or other mechanism. As rotation of the flywheel rotor 32 continues from FIG. 2B the flapper is released and begins to compress the air-fuel mixture as being shown in FIG. 2C. This is the compression cycle as the flapper rotation 91 approaches the flywheel rotor 32.

In FIG. 2D the compression cycle completes with maximum compression and the spark plug 60 creates plug ignition 61. The flapper 31 is again locked in position whereby the flywheel rotor 32 is pushed by the expanding ignition from the air-fuel mixture causing rotation of the flywheel rotor 32.

In FIG. 2E the trailing edge of the flywheel rotor 32 opens a path for the expended gases from the ignition to enter the exhaust port 42 manifold. The flapper 31 is released and begins to rotate 92 towards the flywheel rotor 32, as shown in FIG. 2F and pushes all the exhaust out through exhaust port 42. This returns the cycles of the rotary actuation engine 21 to the condition found back in FIG. 2A to begin another cycle of the rotary actuation engine 21.

The location and/or openings for the intake and exhaust ports can change or move based upon the rotation 90 speed of the engine. The location and timing of ignition 61 may also change as the engine speed changes and the power demand on the engine varies.

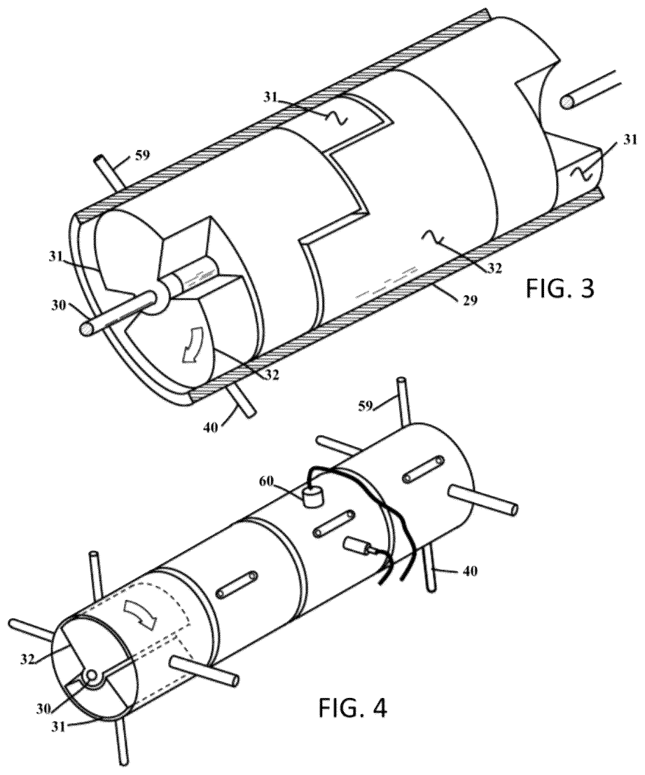

FIG. 3 shows a second embodiment of the rotary actuation engine 21. In this embodiment sections of the flywheel rotor 32 are linked together is a longitudinal arrangement along with linked flappers 31 across multiple chambers in the engine block 29. This figure shows the driveshaft 30 passing through the multiple chambers. A fuel injector 59 is shown on top of the engine block 29 along with an exhaust tube 40 below the engine block 29.

FIG. 4 shows four rotary actuation engine modules connected through a common driveshaft 30. In the first module the outer cover of the module has been removed to show the flapper 31 and the flywheel rotor 32. The flapper 31 and flywheel rotor 32 of each module is offset by 90 degrees so the power rotation has a smooth transition as each module progressively proves rotational power. While this figure shows four modules, while four modules is shown the engine can be made with as few as one module to many more than 4 modules, with each module being evenly rotationally offset based upon the number of modules. This figure further shows exhaust tube(s) 40, fuel injector(s) 59 and spark plug(s) 60 spaced around the engine modules.

The intake passage 51 and exhaust passage 41 may be formed as internal channels within the engine block

In some embodiments, the engine block 29 defines one or more internal flow paths including an intake passage 51 configured to route intake air and/or an air-fuel mixture from the intake tube 50 and intake port 53 into the combustion chamber, and an exhaust passage 41 configured to route combustion products from the combustion chamber to the exhaust port 43, exhaust manifold region 42, and exhaust tube 40. The intake passage 51 and exhaust passage 41 may be formed as internal channels in the engine block 29 and/or as openings and plenum regions in one or more end plates or housing portions, and may be arranged axially, radially, or in a combination thereof.

In some embodiments, at least one of the intake passages and the exhaust passage is positioned at an angular location corresponding to a maximum-volume region of a variable-volume combustion chamber. A circumferential seal rim or overlap lip moves relative to the passage to selectively place the combustion chamber in fluid communication with the passage during a defined rotational interval and to re-seal the chamber outside the interval. The passage may thereby be opened during a scavenging or charging phase and closed during compression and expansion phases

In some embodiments, the arc-shaped sector element remains in continuous relative motion with respect to the rotating cylindrical body and combustion pressure biases the relative angular velocity to generate torque; in other embodiments, a control arrangement constrains sector motion over selected angular intervals, including by mechanical stops, detents, or latches, to create dwell phases

FIG. 5 shows a magnetic rotary engine embodiment with a spinning cylinder. This embodiment has a positive +and a negative-field at each end of the cylinder. Electrical power generates spinning plus and minus fields around the spinning cylinder to generate power that can be transferred though a central shaft to perform work for propulsion or to power a product.

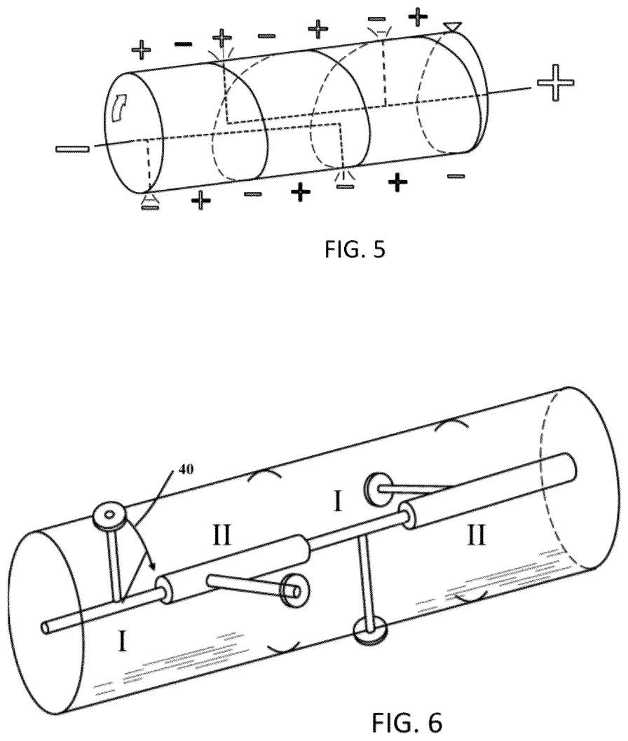

FIG. 6 shows intake ports placed in 90-degree rotations around the four-module rotary actuation engine. These create torque 70 to turn the engine. There are two sets of different sections, I and II, that are alternately placed in series in the engine to evenly distribute the combustion cycles at different phases of rotation.

Control Arrangement for Arc-Sector Motion. In operation, the arc-shaped sector element may be held in one or more angular positions relative to the housing or rotating cylindrical body to define chamber boundaries during at least compression and expansion phases. A control arrangement may be configured to constrain relative motion between the arc-shaped sector element and the rotating cylindrical body during selected portions of a cycle and to permit relative motion during other portions of the cycle to effect chamber volume change and gas exchange. The control arrangement may be mechanical, hydraulic, electromagnetic, or a combination thereof, and may be referenced to a rotational position of the driveshaft.

Embodiment A: Cam track and follower with dwell and ramp regions. In one embodiment, the control arrangement includes a cam track fixed to the housing or end plate and a follower coupled to the arc-shaped sector element. The cam track defines one or more dwell regions that maintain the arc-shaped sector element at a substantially fixed angular position relative to the housing over a selected range of driveshaft rotation. The cam track further defines one or more ramp regions that urge the follower to move, thereby rotating or repositioning the arc-shaped sector element relative to the rotating cylindrical body to change combustion chamber volume. The follower may be a roller follower, sliding shoe, or pin follower, and may be spring-biased toward the cam track to maintain contact. The dwell region may correspond to a compression dwell, an ignition/expansion dwell, or an exhaust dwell, while the ramp region may correspond to an intake sweep or exhaust sweep. The cam track may be annular and arranged on an end plate so that timing is set by angular position about the driveshaft axis. In some embodiments, the cam track profile is replaceable or adjustable to vary phasing, dwell duration, or lift as a function of speed or load.

Embodiment B: Detant of pawl locking with timed release. In another embodiment, the control arrangement includes a detent or pawl configured to engage a corresponding notch, pocket, or tooth structure coupled to the arc-shaped sector element. Engagement of the detent or pawl constrains motion of the arc-shaped sector element relative to the housing during at least a portion of compression and expansion. A timed release cam or eccentric mounted on the driveshaft is configured to disengage the detent or pawl at a selected rotational position, thereby permitting the arc-shaped sector element to move relative to the rotating cylindrical body. The detent or pawl may be biased toward engagement by a spring or fluid pressure, and may include a wear-compensating interface to reduce backlash. In some embodiments, multiple engagement positions are provided to allow different dwell angles or compression ratios. In some embodiments, a damping element is included to reduce impact loads during engagement and disengagement.

Embodiment C: Electromagnetic latch or actuator. In another embodiment, the control arrangement includes an electromagnetic latch configured to selectively constrain the arc-shaped sector element relative to the housing or a reference structure. The electromagnetic latch may comprise a solenoid-actuated pawl, a magnetically biased latch, or an electromechanical brake coupled to the arc-shaped sector element. A controller may energize the latch based on driveshaft angular position to hold the arc-shaped sector element during selected phases and de-energize the latch to permit motion during other phases. In some embodiments, the electromagnetic latch is combined with a mechanical stop so that combustion loads are reacted through a defined load path. In some embodiments, an electric motor-generator coupled to the driveshaft provides baseline rotation and the electromagnetic latch coordinates arc-sector timing during startup and low-speed operation.

Thus, specific embodiments of a rotary actuation engine have been disclosed. It should be apparent, however, to those skilled in the art that many more modifications besides those described are possible without departing from the inventive concepts herein. The inventive subject matter, therefore, is not to be restricted except in the spirit of the appended claims.

What is claimed is:

1. A rotary actuation engine comprising:
a housing;
a driveshaft rotatably supported relative to the housing;
a rotating cylindrical body coupled to the driveshaft and configured to rotate with the driveshaft, the rotating cylindrical body defining at least a portion of a combustion chamber boundary;
an internal arc-shaped sector element positioned within the housing and arranged to move relative to the rotating cylindrical body, the arc-shaped sector element being pivotably or movably supported relative to the driveshaft or the housing;
wherein relative movement between the rotating cylindrical body and the arc-shaped sector element increases and decreases a volume of a combustion chamber defined therebetween;
an intake passage positioned on the housing and an exhaust passage positioned on the housing and in fluid communication with the combustion chamber;
a fuel delivery arrangement configured to deliver fuel to the combustion chamber;
an ignition device positioned to initiate combustion within the combustion chamber;
and a control arrangement configured to control relative motion between the arc-shaped sector element and the rotating cylindrical body such that, during operation, the combustion chamber undergoes intake, compression, expansion, and exhaust phases while the driveshaft remains in continuous rotation, wherein combustion within the combustion chamber applies incremental torque to the rotating cylindrical body to rotate the driveshaft.

2. The rotary engine of claim 1, wherein at least one of the intake passage and the exhaust passage has a variable effective position, timing, or opening area relative to the combustion chamber based on a rotational speed of the driveshaft.

3. The rotary engine of claim 1, wherein the control arrangement is configured to vary timing of intake, compression, expansion, or exhaust phases as a function of rotational speed or load.

4. The rotary engine of claim 1, wherein the arc-shaped sector element is pivotably supported about an axis parallel to or coincident with the rotational axis of the driveshaft.

5. The rotary engine of claim 1, wherein the arc-shaped sector element is movably supported by a cam, linkage, track, or guide structure configured to control relative motion between the arc-shaped sector element and the rotating cylindrical body.

6. The rotary engine of claim 1, further comprising at least one circumferential sealing ring positioned between the outer surface of the rotating cylindrical body and the inner surface of the housing, and at least one sealing ring at each axial end of the arc-shaped sector, wherein the seal rim or overlap lip cooperates with the sealing rings to define a timed port window while maintaining substantial sealing of the combustion chamber during compression and expansion phases.

7. The rotary engine of claim 6, wherein the sealing interface comprises at least one of a ring seal, a pressure-biased seal, a compliant seal, or a labyrinth seal.

8. The rotary engine of claim 1, wherein intake and exhaust flow are routed through ports formed in an end plate of the housing and communicate axially with the combustion chamber.

9. The rotary engine of claim 1, wherein intake and exhaust flow are routed through ports formed radially in the housing and are timed by rotation of the rotating cylindrical body.

10. The rotary engine of claim 1, wherein a plurality of arc-shaped sector elements are provided within the housing and arranged at different angular positions about the rotational axis.

11. The rotary engine of claim 1, comprising a plurality of rotary engine modules coupled to a common driveshaft, each module being angularly offset from an adjacent module to smooth torque delivery.

12. The rotary engine of claim 11, wherein the plurality of rotary engine modules are offset by substantially equal angular increments.

13. The rotary engine of claim 1, wherein the driveshaft is coupled to or formed as an electric motor-generator configured to apply a baseline rotational torque to the driveshaft.

14. The rotary engine of claim 13, wherein the electric motor-generator is configured to initiate rotation of the driveshaft prior to combustion.

15. The rotary engine of claim 13, wherein the electric motor-generator is configured to assist, resist, or stabilize rotational speed during combustion operation.

16. The rotary engine of claim 13, wherein combustion within the combustion chamber provides incremental torque in addition to torque provided by the electric motor-generator.

17. The rotary engine of claim 1, wherein the control arrangement comprises an electronic controller configured to coordinate fuel delivery, ignition timing, and relative motion of the arc-shaped sector element.

18. The rotary engine of claim 17, wherein the electronic controller adjusts operation based on at least one of rotational speed, load, temperature, or pressure.

19. The rotary engine of claim 1, wherein the control arrangement comprises a detent or pawl configured to selectively lock the arc-shaped sector element relative to the housing and a timed release member coupled to the driveshaft and configured to release the detent or pawl at a selected angular position of the driveshaft.

20. The rotary engine of claim 1, wherein at least one of the intake passage and the exhaust passage is located at an angular position corresponding to a maximum-volume region of the combustion chamber, and wherein a seal rim or overlap lip selectively covers and uncovers the passage to define an open interval for gas exchange.
